(19) United States
(12) Patent Application Publication
(10) Pub. No.: US 2010/0171709 A1
(43) Pub. Date: Jul. 8, 2010

(54) PORTABLE ELECTRONIC DEVICE HAVING TOUCH SCREEN AND METHOD FOR DISPLAYING DATA ON TOUCH SCREEN

(75) Inventor: Shinji TOYOKAWA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/541,287

(22) Filed: Aug. 14, 2009

(30) Foreign Application Priority Data
Jan. 6, 2009 (JP) P2009-000969

(51) Int. Cl. G06F 3/041; H04M 1/00

(52) U.S. Cl. 345/173; 455/566

(57) ABSTRACT

A portable electronic device having a touch screen, a memory and a controller is provided. The touch screen is configured to display a screen including an item to be operated on the touch screen. The memory is configured to store data of a relationship between the item and a reaction to be performed upon the item being operated on the displayed screen. The controller is configured to extract the item from the displayed screen. The controller is configured to provide the extracted item with an identifier and to show the extracted item overlaid with the identifier on the displayed screen. The controller is configured to show an identifier button corresponding to the identifier on the displayed screen. The controller is configured to perform the reaction with reference to the data stored in the memory upon the identifier button being operated on the displayed screen.

### CROSS REFERENCE TO RELATED APPLICATIONS

This application is based upon and claims the benefit of priority from the prior Japanese Patent Application No. 2009-969 filed on Jan. 6, 2009;

the entire contents of which are incorporated herein by reference.

### BACKGROUND OF THE INVENTION

1. Field of the Invention

The present invention relates to a portable electronic device having a touch screen for displaying and entering data, and a method for displaying data on the touch screen. In particular, the present invention relates to a portable electronic device configured to show interfaces such as a hyperlink and a text box in such a way that the interfaces are gathered at a portion that a user can select with a finger of one hand that holds the portable electronic device.

2. Description of the Related Art

In recent years, more and more portable electronic devices such as mobile phones are downsized, and a growing number of them allow users' one-handed operation. In a case, however, where a user holds a portable electronic device and operates its touch screen with one hand, the user can hardly operate an item of a menu only with a finger of the hand that holds the portable electronic device if the item is shown apart from the finger.

Thus, a data processing device configured to optimize a display function for a user while the user is not aware of that and to be easily held is disclosed in Japanese Patent Publication of Unexamined Application (Kokai) No. 2008-27183. The data processing device of JP 2008-27183 has a flat and nearly rectangular housing of a size that can be held by one hand. The housing has a main face and two side faces on both sides of the main face. The data processing device of JP 2008-27183 has a display unit including a screen face provided on the main face, a sheet-like pressure sensor for sensing a distribution of a contact area between the two side faces and a user's hand, and a controller configured to control content displayed on the screen of the display unit on the basis of an output of the pressure sensor.

Meanwhile, portable electronic devices such as mobile phones have multiple sophisticated functions these days, and a growing number of them have a touch screen each on which a user can perform an input operation by touching the screen. As an amount of data that can be displayed by such a portable electronic device at the same time increases, sizes of fonts and images shown on the touch screen are reduced in order to provide the user with more information. Even the sizes of items such as a hyperlink, a select button, a text box and so on which are operated by a user are reduced on the touch screen. In particular, if the size of such an item is so reduced as to be smaller than a user's finger on the touch screen, the user can hardly select a desired item by using his or her finger.

If an item to be operated is shown at a position on the touch screen that a finger of a user's hand holding the portable electronic device cannot reach, the user can hardly select the item by using that finger.

### SUMMARY OF THE INVENTION

Accordingly, an advantage of the present invention is that a portable electronic device having a touch screen configured to display data and to accept an input operation is provided. The portable electronic device of the present invention can display lots of data on the touch screen at the same time. A user can easily select an item to be operated shown on the touch screen of the portable electronic device of the present invention.

In order to achieve the above advantage, a portable electronic device having a touch screen, a memory and a controller is provided. The touch screen is configured to display a screen including an item to be operated on the touch screen. The memory is configured to store data of a relationship between the item and a reaction to be performed upon the item being operated on the displayed screen. The controller is configured to extract the item from the displayed screen. The controller is configured to provide the extracted item with an identifier and to show the extracted item overlaid with the identifier on the displayed screen. The controller is configured to show an identifier button corresponding to the identifier on the displayed screen. The controller is configured to perform the reaction with reference to the data stored in the memory upon the identifier button being operated on the displayed screen.

### BRIEF DESCRIPTION OF THE DRAWINGS

FIG. 1 is a perspective view showing a portable electronic device (mobile phone) of an embodiment of the present invention.

FIG. 2 is a block diagram of the portable electronic device (mobile phone) of the embodiment.

FIG. 3A shows an example of a screen of the portable electronic device (mobile phone) of the embodiment displaying a Web page.

FIG. 3B shows an example of a screen of the portable electronic device (mobile phone) of the embodiment showing a Web page and an input panel for selecting an item to be operated on the Web page.

FIGS. 4 is a flowchart showing a procedure of a display control process performed by the portable electronic device (mobile phone) of the embodiment.

FIG. 5 shows a data structure of relation data of the embodiment between items to be operated and identifier data.

FIG. 6 shows an example of a displayed screen of the embodiment upon an item being selected on the input panel shown on the screen.

FIG. 7 shows another example of a displayed screen of the embodiment upon an item being selected on the input panel shown on the screen.

FIG. 8 shows a yet another example of a displayed screen of the embodiment upon an item being selected on the input panel shown on the screen.

FIG. 9 shows another example of a screen of the portable electronic device (mobile phone) of the embodiment displaying a Web page and an input panel for selecting an item to be operated on the Web page.

FIG. 10 shows yet another example of a screen of the portable electronic device (mobile phone) of the embodiment displaying a Web page and an input panel for selecting an item to be operated on the Web page.

### DETAILED DESCRIPTION OF THE INVENTION

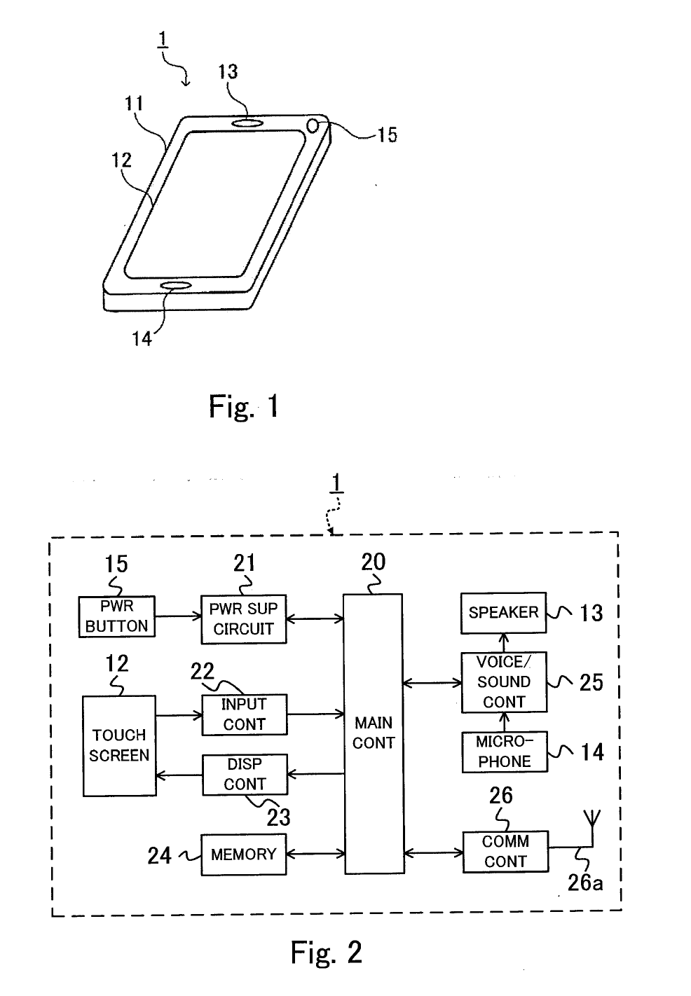

An embodiment of the present invention will be described with reference to FIGS. 1-10. A card-shaped mobile phone 1 will be explained as an example of the present invention. The mobile phone 1 is configured in such a way that a user can operate the mobile phone 1 with his or her finger. FIG. 1 shows a perspective view of the mobile phone 1.

As shown in FIG. 1, the mobile phone 1 has a rectangular plate-like housing 11. The housing 11 is provided on one face with a touch screen 12, a speaker 13 and a microphone 14. The touch screen 12 is configured to display a screen formed by text, an image and so on, and to accept data input by sensing contact with a finger, a stylus and so on. The speaker 13 is configured to produce voice and sound. The microphone 14 can be used for entering voice and sound. The mobile phone 1 is provided with a power button 15 that can be used for turning on or off power supplied to the mobile phone 1.

The touch screen 12 has both a display function for displaying a screen formed by text, an image and so on, and an input function for sensing contact with a finger or a dedicated stylus so as to accept data input on the basis of a position of the contact. The touch screen 12 is constituted by a display, a plurality of elements for sensing a touch on the surface of the display arranged on top of the display, and a transparent screen layered above the elements. Methods for sensing a touch on the touch screen 12 may be a pressure sensing method for sensing a pressure change, an electrostatic method for sensing a signal caused by static electricity and so on.

Then, functions of the mobile phone 1 will be explained with reference to a functional block diagram shown in FIG. 2. The mobile phone 1 is constituted by a main controller 20, a power supply circuit 21, an input controller 22, a display controller 23, a memory 24, a voice/sound controller 25 and a communication controller 26 which are electrically connected to one another through a bus.

The main controller 20 has a CPU (central processing unit), and is configured to control the whole of the mobile phone 1. The main controller 20 is configured to perform a display control process that will be described later, other various arithmetic and control processes and so on. The power supply circuit 21 is configured to turn on or off the power supply on the basis of a user's input through the power button 15. If the power supply is turned on, the power supply circuit 21 supplies each of portions of the mobile phone 1 with power from a built-in power source (a battery and so on) or an externally connected power source, so as to activate the mobile phone 1.

The input controller 22 has an input interface to the touch screen 12. The input controller 22 is configured, e.g., to sense pressure applied to the touch screen 12, to generate a signal indicating a position at which the pressure is applied, and to provide the main controller 20 with the signal. The display controller 23 has a display interface to the touch screen 12. The display controller 23 can be controlled by the main controller 20 so as to display a screen including text, an image and so forth on the touch screen 12.

The memory 24 is constituted by memory devices such as a ROM (read only memory), a hard disk, a non-volatile memory, a RAM (random access memory) and so on. The ROM and the hard disk are configured to store a program of a process to be performed by the main controller 20, data necessary for the process and so on. The RAM is configured to temporarily store data that the main controller 20 uses while performing the process. The memory 24 stores a program and data that the main controller 20 uses for the display control process.

The voice/sound controller 25 can be controlled by the main controller 20 so as to produce an analog voice signal from a voice input coming through the microphone 14 and to transform the analog voice signal into a digital voice signal. Moreover, upon obtaining a digital voice signal, the voice/sound controller 25 can be controlled by the main controller 20 so as to transform the digital voice signal into an analog voice signal, and to produce voice from the speaker 13.

The communication controller 26 can be controlled by the main controller 20 so as to de-spread a spread-spectrum signal received from a base station through the antenna 26a so as to restore data carried by the received signal. The communication controller 26 can be directed by the main controller 20 to provide the data to the voice/sound controller 25 so that voice based on the data is produced through the speaker 13, to the display controller 23 so that the data is displayed on the touch screen 12, or to the memory 24 so that the data is stored in the memory 24.

Moreover, upon obtaining a voice signal entered through the microphone 14, data entered through the touch screen 12 or data stored in the memory 24, the communication controller 26 performs a spectrum spreading process on those data signals and sends them to the base station through the antenna 26a.

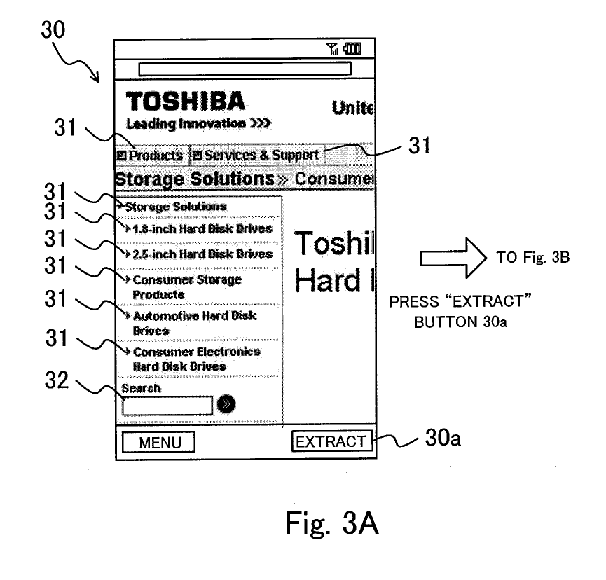

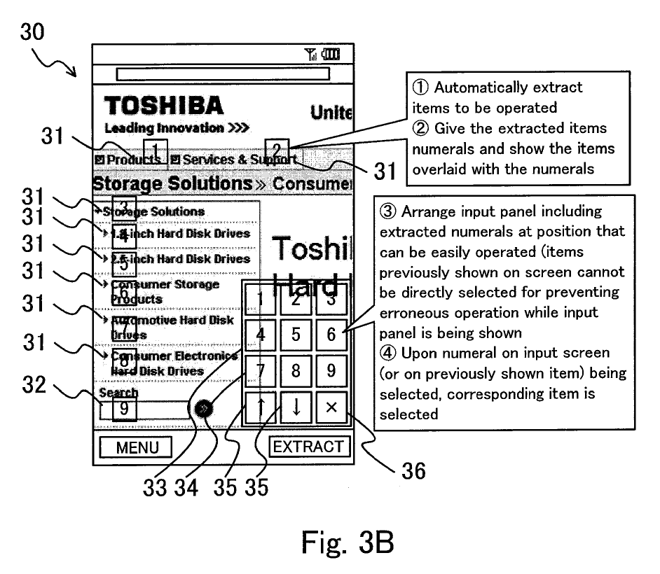

As implementing sophisticated functions, a portable electronic device such as the mobile phone 1 shows lots of data, e.g., on a screen 30 displayed on the touch screen 12 as shown in FIG. 3A. Then, the size of each of items included in the screen 30 shown on the touch screen 12 is reduced, resulting in that a user can hardly select a desired one of the items exactly with a finger of the one hand that holds the mobile phone 1.

Moreover, if data is shown on the whole of the screen 30 displayed on the touch screen 12 while the user holds the mobile phone 1, the user cannot reach some area of the screen 30 with a finger of the one hand that holds the mobile phone 1. In such a case, the user possibly has to operate the touch screen 12 with a finger of the other hand that does not hold the mobile phone 1.

In order to address such a problem, the mobile phone 1 is configured to extract items of the data included in the screen 30 which can be operated by a user, and to display the extracted items in such a way as to be gathered around the finger of the user's hand that holds the mobile phone 1, so that the user can easily operate the touch screen 12 with the finger of the one hand that holds the mobile phone 1.

That is, the mobile phone 1 extracts an item to be operated from the screen 30 on the touch screen 12. Assume, e.g., that the screen 30 displays a Web page, and that a plurality of hyperlinks 31 and a text box 32 which can be operated by a user are shown on the screen 30, as shown in FIG. 3A. Then, the mobile phone 1 provides each of the items to be operated with an identifier (e.g., an identification number), and shows each of the items overlaid with the identifier on the screen 30, as shown in FIG. 3B.

As shown in FIG. 3B, e.g., two hyperlinks 31 shown on a top portion of the screen 30 are provided and overlaid with numerals “1” and “2”. Six hyperlinks 31 piled up in a middle to lower portion of the screen 30 are provided and overlaid with numerals “3” to “8”. A text box 32 shown on a bottom portion of the screen 30 is provided and overlaid with a numeral “9”.

Meanwhile, the mobile phone 1 arranges in an input panel 33 a plurality of identifier buttons 34 each of which corresponds to each of the identifiers provided to the items to be operated by a user, and displays the screen 30 overlaid with the input panel 33 located at a position that the user can easily operate with a finger of the one hand that holds the mobile phone 1. At this time, while showing the input panel 33 on the screen 30, the mobile phone 1 makes each of the items previously shown on the screen 30 ineffective so as to prevent an erroneous operation.

The mobile phone 1 relates each of the identifier buttons 34 included in the input panel 33 to each of the items shown on the screen 30. A user can equivalently select one of the items related to one of the identifier buttons 34 included in the input panel 33 by selecting that particular identifier button 34, and the mobile phone 1 performs a process on the screen 30 in accordance with the selected item.

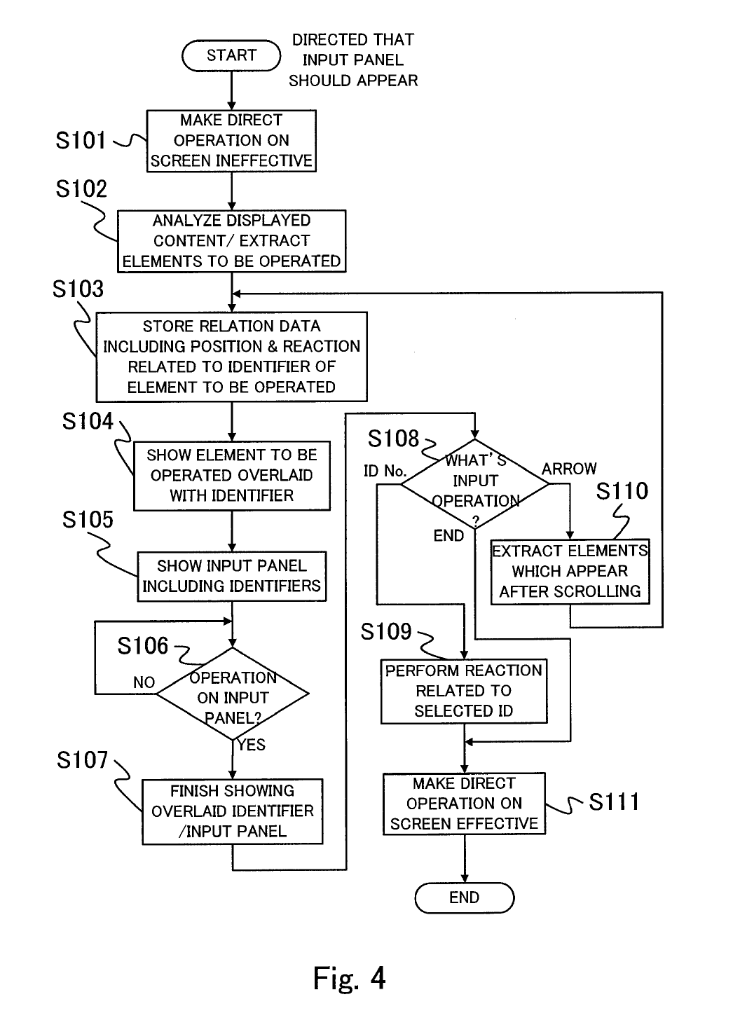

If items to be operated by a user are shown on the touch screen 12, the mobile phone 1 shows the items to be operated in such a way as to be gathered around a finger of the one hand holding the mobile phone 1 by using the input panel 33, e.g., in accordance with a certain operation of the user performed on the touch screen 12. A portion around a finger of the one hand holding the mobile phone 1 is preferably, although not limited to, a portion around a lower right fixed point (i.e., a corner) of the mobile phone 1, and may be a portion around another fixed point. A procedure of the display control process performed by the mobile phone 1 will be described with reference to a flowchart shown in FIG. 4. Hereafter, a term such as “step S101” is shortened as “S101” by omitting the term “step”.

If the mobile phone 1 displays the screen 30 on the touch screen 12, a user can, e.g., select an “extract” button 30a shown on the screen 30, or touch and linearly trace the touch screen 12. The user can thereby direct the mobile phone 1 that the input panel 33 for operating a hyperlink, a text box and so on shown on the screen 30 should appear on the screen 30. Upon being directed by the user that the input panel 33 should appear, the main controller 20 first makes a direct operation performed on the screen 30 ineffective so as to prevent an erroneous operation such as multiple actions caused by a single operation (S101). That is, the main controller 20 controls the touch screen 12 in such a way that a user's operation for selecting one of the hyperlinks 31 and so on shown on the screen 30, as shown in FIG. 3B, is made ineffective.

The main controller 20 analyzes content displayed on the screen 30, and extracts a certain number of items to be operated by a user, such as a hyperlink, an operation button, a text box, a selection box and so on (S102). The above number of the items is the number that can be included in the input panel 33, e.g., nine identified by the identifiers 1” to “9”. If the items to be operated are fewer than the above number, all the items to be operated are extracted.

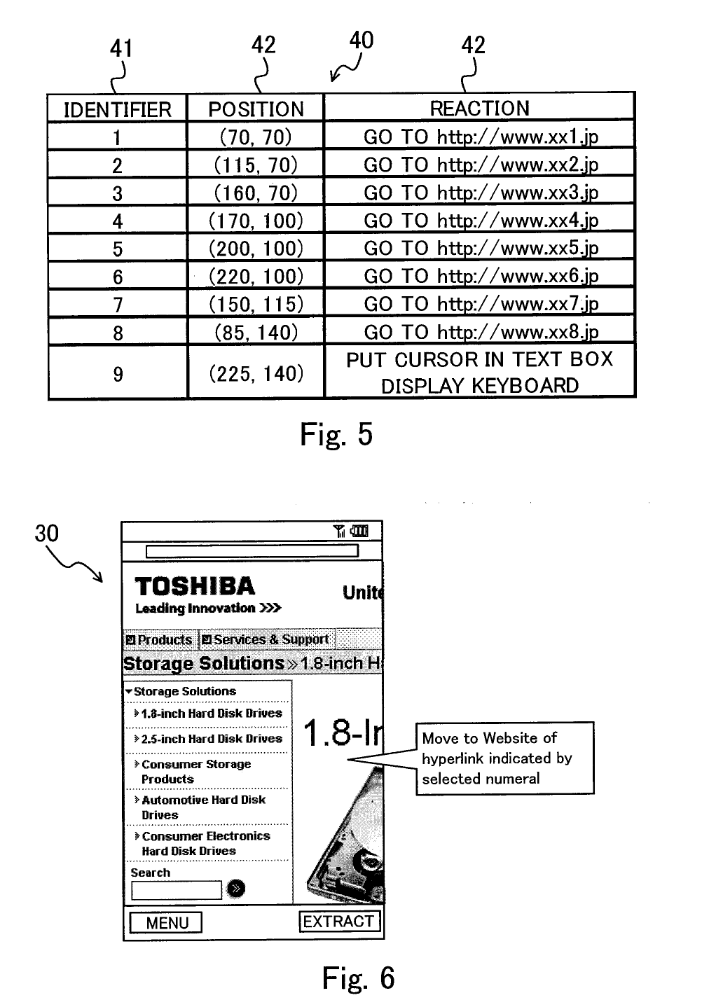

The main controller 20 relates the position of, and a reaction to, each of the items to be operated to the corresponding identifier so as to generate relation data 40, and to store the relation data 40 in the memory 26 (S103). The relation data 40 is formed, e.g., as shown in FIG. 5, by identifier data 41, position data 42 and reaction data 43. The identifier data 41 includes the identifiers of the items to be operated. The position data 42 includes a position of each of the items that is related to the corresponding identifier. The reaction data 43 includes a reaction to each of the items that is related to the corresponding identifier.

The relation data 40 relates, e.g., as shown in FIG. 5, the item of the identifier “1” to a position (70, 70) and a reaction “GO TO http://www.xx1.jp”. The relation data 40 relates the item of the identifier “9” to a position (225, 140) and a reaction “PUT CURSOR IN TEXT BOX/DISPLAY KEYBOARD”.

The main controller 20 shows each of the items to be operated extracted at S102 overlaid with the identifier related to the item at S103 (S104). As each of the identifiers are shown close to each of the items, e.g., as shown in FIG. 3B, a user can tell which one of the items is related to which one of the identifiers.

The main controller 20 shows the input panel 33 on the screen 30 around a portion of the mobile phone 1 at which a user holds the mobile phone 1 (around a portion of the mobile phone 1 being lower right to the screen 30 if the user holds the mobile phone 1 with his or her right hand) (S105). The identifier buttons 34 are arranged in such a way as to be selected by the user on the input panel 33. As shown in FIG. 3B, e.g., the input panel 33 on which the identifier buttons 34 provided with identifiers “1” to “9” are arranged is shown on the screen 30. The input panel 33 includes arrow buttons 35 such as an upward arrow for showing items to be operated after scrolling up and a downward arrow for showing items to be operated after scrolling down. The input panel 33 includes an end button 36 indicated by “X” for closing the input panel 33.

A user can operate the input panel 33 by touching the identifier buttons 34, the arrow buttons 35 and the end button 36 at will with a finger of his or hers. Then, the main controller 20 judges whether there is an operation on the input panel 33 (S106). If there is no operation on the input panel 33 (“NO” of S106), the main controller 20 waits for an operation on the input panel 33.

If there is an operation on the input panel 33 (“YES” of S106), the main controller 20 finishes showing the identifier and the input panel 33 continuing to be displayed since S104 and S105, respectively (S107).

The main controller 20 judges what the input operation at S106 is (S108). If one of the identifier buttons 34 indicated by the identifiers “1” to “9” and included in the input panel 33 is selected (“ID No.” of S108), the main controller 20 performs the reaction related to the selected identifier on the basis of the relation data 40 stored in the memory 26 at S103 (S109).

If a user selects the identifier button 34 indicated by “4”, the main controller 20 performs the reaction “GO TO http://www.xx4.jp” that the relation data 40 relates to the identifier “4” so that, as shown in FIG. 6, the linked Web page appears on the screen 30 displayed on the touch screen 12.

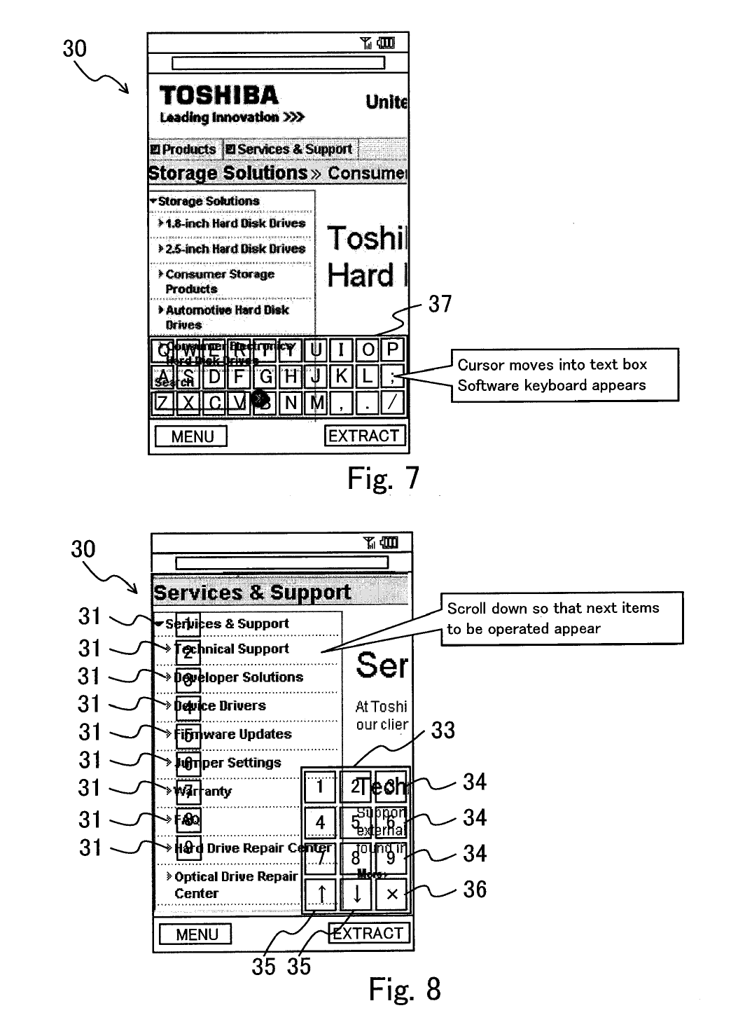

If a user selects the identifier button 34 indicated by “9”, the main controller 20 performs the reaction “PUT CURSOR IN TEXT BOX/DISPLAY KEYBOARD” that the relation data 40 relates to the identifier “9” so that, as shown in FIG. 7, a cursor is put in the text box 32 and a software keyboard 37 appears in a lower portion of the screen 30. The user can touch a position of each of the keys on the screen 30 showing the software keyboard 37 by using a finger, a stylus and so on, so that a character corresponding to the touched key (and consequently text formed by such characters) is entered in the text box 32.

If a user selects the upward arrow button 35 (“ARROW” of S108), the main controller 20 extracts a certain number of items which appear after scrolling up instead of the items extracted at S102. If a user selects the downward arrow button 35 (“ARROW” of S108), the main controller 20 extracts a certain number of items which appear after scrolling down instead of the items extracted at S102. Then, returning to S103, the main controller 20 performs the process S103-S108 again.

Assume, e.g., that the downward arrow button 35 is selected while the items to be operated are provided with the identifiers as shown in FIG. 3B. Then, as shown in FIG. 8, the main controller 20 provides from the beginning each of the items to be operated which appear after scrolling down with an identifier in top to bottom order. The main controller 20 shows the identifiers on the screen 30 at S104. The main controller 20 shows the input panel 33 corresponding to the identifiers at S105.

After performing the reaction corresponding to the selected identifier at S109, or if a user selects the end button 36 (“END” of S108), the main controller 20 makes a direct operation performed on the screen 30 effective, which was made ineffective at S101 (S111). Thus, the screen 30 returns to the state shown in FIG. 3A, and enables a user to touch the screen 30 by using a finger, a stylus and so on so as to operate the mobile phone 1.

As described above, as the mobile phone 1 shows items to be operated by a user on the touch screen 12, the mobile phone 1 extracts the items to be operated and provides each of the items with an identifier. The mobile phone 1 shows each of the items overlaid with the identifier. The mobile phone 1 shows the input panel 33 on a portion of the screen 30 that can be easily operated by the user. Each of the identifier buttons 34 which are included in the input panel 33 is related to each of the items.

A user can select each of the items by selecting each of the identifier buttons 34 on the input panel 33. If the item selected by the user is a hyperlink, the mobile phone 1 shows content of a Website that the hyperlink is linked to. If the item selected by the user is a text box for entering text, the mobile phone 1 moves a cursor into the text box and shows the software keyboard 37. If the item selected by the user is one of the arrow buttons 35, the mobile phone 1 changes an area from which items to be arranged in the input panel 33. At this moment, the mobile phone 1 may be so configured that the screen 30 can scroll as necessary.

If the number of the items to be extracted is unlimited, visibility or operability of the mobile phone 1 may possibly be degraded. Thus, the mobile phone 1 is configured to limit the number of the items to be extracted, and to work as changing the area from which the items can be selected.

Moreover, the mobile phone 1 makes an input operation performed on an item previously shown on the screen 30 ineffective so as to prevent an erroneous operation while showing the input panel 33 on the screen 30. At this moment, it is preferable to stress contrast between the input panel 33 and the rest of the screen 30 in order to clarify an effective item to be operated.

In order that a user can easily extract an item to be operated, the mobile phone 1 may enlarge items to be extracted on the screen 30, an identifier provided to each of the items on the screen 30, or the identifier buttons included in the input panel 33. The mobile phone 1 may change the position of the input panel 33 on the screen 30 in accordance with a user's hand that holds the mobile phone 1. If the user holds the mobile phone 1 with his or her right hand, e.g., the input panel 33 should be shown on the lower right portion of the screen 30. If the user holds the mobile phone 1 with his or her left hand, the input panel 33 should be displayed on the lower left portion of the screen 30.

The mobile phone 1 may extract items to be operated and show the input panel 33 upon the touch screen 12 sensing a long push. At this moment, the input panel 33 may be shown on a portion where the long push has been sensed.

If items to be operated are shown crowded on the screen 30, a plurality of identifiers shown on the screen 30 may possibly overlap one another and thus may hardly be viewed separately. In such a case, the mobile phone 1 may show each of the identifiers apart from one another, not on top of the item to be operated. In that event, the mobile phone 1 should link the identifier and the item related to the identifier by a line so as to clarify their relationship.

The embodiment of the present invention described above is so configured that items to be operated are provided with identifiers each, and that the identifier buttons corresponding to the identifiers each are included in the input panel 33. The present invention is not limited to the above embodiment, and may be configured to work, e.g., as shown in FIG. 9. The items to be operated are provided with identifiers formed by text in FIG. 9, such as data indicating a destination of a hyperlink if the item to be operated is the hyperlink, data indicating content to be entered into a text box if the item to be operated is the text box, and so on. Identifier buttons 34A indicating such text may be included in an input panel 33A so that a user can select one of the items on the basis of the text. A screen described in HTML (hyper text markup language) may be displayed on the basis of attribution data such as “alt (alternative text)”. Moreover, if a screen is generated by an application program, a name may be extracted from an interface of the application program and displayed.

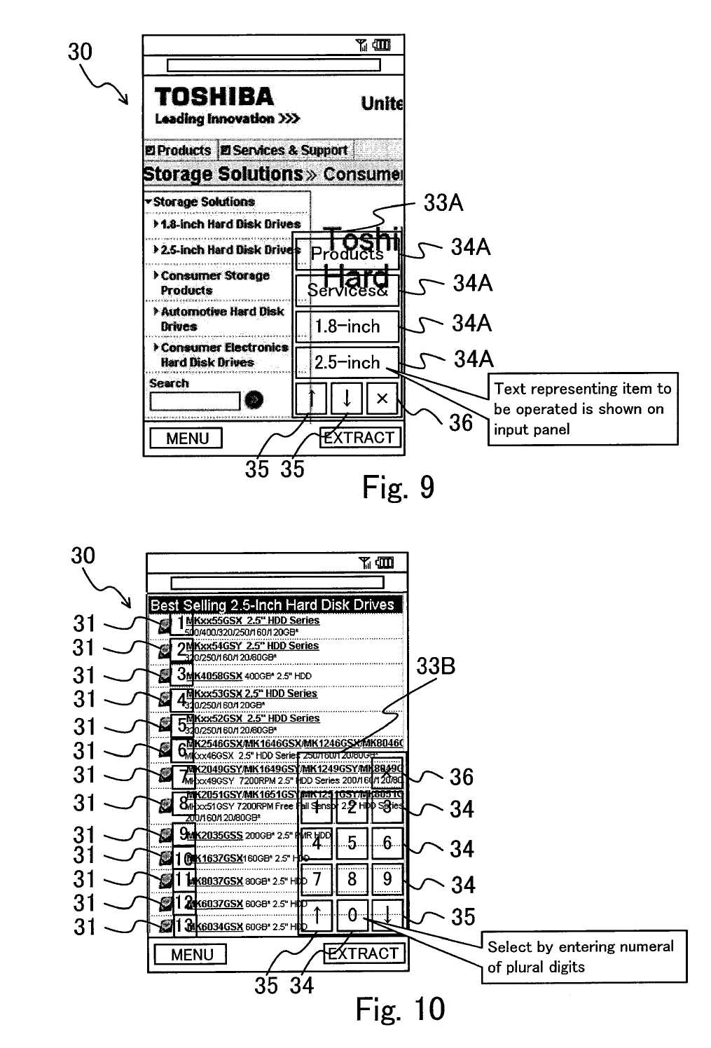

The embodiment of the present invention described above is so configured that the items to be operated are provided with the identifiers “1” to “9” and nine items are included in the input panel 33. The present invention is not limited to the above embodiment, and may be configured to work, e.g., as shown in FIG. 10. More than nine items are provided with identifiers and an input panel 33B in which the identifier buttons 34 of “0” to “9” is shown in FIG. 10. A user can select a plurality of the identifier buttons 34 on the input panel 33B so as to enter an identifier of more than one digit. If, e.g., the user selects “0” and “2” in order on the input panel 33, the identifier “2” is supposed to be selected. If, e.g., the user selects “1” and “2” in order on the input panel 33, the identifier “12” is supposed to be selected.

The above explanation of the present invention gives a case where a Web page is displayed on the touch screen 12. The present invention is not limited to such a case, and the display controller process can be applied to any screen showing items to be operated.

The portable electronic device of the present invention (mobile phone 1) has a touch screen adapted for both displaying and entering data so that lots of data can be displayed on the touch screen 12 at the same time. The mobile phone 1 can show items of the displayed data to be operated in such a way that the items are gathered around a finger of the user's hand that holds the mobile phone 1 so that the user can easily select one of the items shown on the touch screen 12 to be operated with one hand.

The above explanation of the present invention gives an example of the mobile phone 1. The present invention is not limited to the above, and may be applied to any kind of portable electronic device having a touch screen, such as a PHS (personal handy-phone system), a PDA (personal digital assistant), a portable music player and a portable game machine.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is

1. A portable electronic device, comprising:
a touch screen configured to display a screen including an item to be operated on the touch screen;
a memory configured to store data of a relationship between the item and a reaction to be performed upon the item being operated on the displayed screen; and
a controller configured to extract the item from the displayed screen, the controller being configured to provide the extracted item with an identifier and to show the extracted item overlaid with the identifier on the displayed screen, the controller being configured to show an identifier button corresponding to the identifier on the displayed screen, the controller being configured to perform the reaction with reference to the data stored in the memory upon the identifier button being operated on the displayed screen.

2. The portable electronic device according to claim 1, wherein the controller is further configured to show the identifier button near a corner of the displayed screen.

3. The portable electronic device according to claim 1, wherein the controller is further configured to show a scroll button on the displayed screen for scrolling the displayed screen, the controller being configured to extract the item after scrolling.

4. The portable electronic device according to claim 1, wherein the controller is further configured to show a button on the displayed screen for starting to extract the item.

5. The portable electronic device according to claim 1, wherein the controller is further configured to show a button on the displayed screen for starting to extract the item, the controller being further configured to make an operation performed on the item on the displayed screen ineffective after the button for starting to extract the item is operated.

6. The portable electronic device according to claim 1, wherein the identifier and the identifier button are given a same numeral.

7. The portable electronic device according to claim 1, wherein the identifier button is shown by text representing the item.

8. The portable electronic device according to claim 1 further comprising a communication unit configured to perform website browsing, wherein the item is a hyperlink to a Website.

9. The portable electronic device according to claim 1, wherein the item is a text box for entering text.

10. The portable electronic device according to claim 1, wherein the item is a text box for entering text, and the controller is further configured to show a software keyboard on the displayed screen upon the item being operated.

11. The portable electronic device according to claim 1, wherein the controller is further configured, upon the displayed screen including a plurality of items to be operated, to extract a given number of the items at most from the displayed screen.

12. The portable electronic device according to claim 1, wherein the controller is further configured, upon the displayed screen including a plurality of items to be operated, to provide each of the extracted items with each of a plurality of identifiers, the controller being configured to show a plurality of identifier buttons each of which corresponds to each of the identifiers on the displayed screen in a gathered manner.

13. A method for displaying data on a touch screen, comprising:
displaying a screen including an item to be operated on the touch screen;
storing data of a relationship between the item and a reaction to be performed upon the item being operated on the displayed screen;
extracting the item from the displayed screen;
providing the extracted item with an identifier;
showing the extracted item overlaid with the identifier;
showing an identifier button corresponding to the identifier on the displayed screen; and
performing the reaction with reference to the data stored in the memory upon the identifier button being operated on the displayed screen.

14. The method for displaying data on the touch screen according to claim 13, wherein the identifier button is shown near a corner of the displayed screen.

15. The method for displaying data on the touch screen according to claim 13, further comprising
showing a scroll button on the displayed screen for scrolling the displayed screen, and
extracting the item after scrolling.

16. The method for displaying data on the touch screen according to claim 13, further comprising
showing a button on the displayed screen for starting to extract the item, and
making an operation performed on the item on the displayed screen ineffective after the button for starting to extract the item is operated.

17. The method for displaying data on the touch screen according to claim 13, wherein the item is a text box for entering text, further comprising showing a software keyboard on the displayed screen upon the item being operated.

18. The method for displaying data on the touch screen according to claim 13, further comprising, upon the displayed screen including a plurality of items to be operated, extracting a given number of the items at most from the displayed screen.

19. The method for displaying data on the touch screen according to claim 13, further comprising, upon the displayed screen including a plurality of items to be operated,
providing each of the extracted items with each of a plurality of identifiers, and
showing a plurality of identifier buttons each of which corresponds to each of the identifiers on the displayed screen in a gathered manner.
